(19) United States
(12) Patent Application Publication
(10) Pub. No.: US 2023/0168939 A1
(43) Pub. Date: Jun. 1, 2023

(54) DEFINITION AND IMPLEMENTATION OF PROCESS SEQUENCES

(71) Applicant: SAP SE, Walldorf (DE)

(72) Inventors: Markus Kahn, KELL AM SEE (DE); Matthias Schauer, RAUENBERG (DE); Mathias Vahle, MANNHEIM (DE); Lothar Muessler, RAUENBERG (DE)

(21) Appl. No.: 17/537,819

(22) Filed: Nov. 30, 2021

(51) Int. Cl. G06F 9/50; G06F 9/48

(52) U.S. Cl. CPC G06F 9/5038; G06F 9/5055; G06F 9/485; G06F 2209/508

(57) ABSTRACT

A method, a system, and a computer program product for defining and implementing various process sequences. One or more first processing parameters for executing a sequence of processes are identified. The sequence of processes includes a plurality of executable computing processes. The first processing parameters define one or more periods of time associated with executing the sequence of processes. At least one subject matter domain parameter associated with the sequence of processes is determined. Based on the subject matter domain parameter, one or more executable computing processes in the plurality of executable computing processes is selected for inclusion in the sequence of processes. The sequence of processes having the selected executable computing processes arranged for execution using a predetermined execution order is generated. Each of the selected executable computing processes in the sequence of processes is executed in accordance with the predetermined execution order.

### TECHNICAL FIELD

This disclosure relates generally to data processing and, in particular, to provide a computing environment for defining and implementing various process sequences.

### BACKGROUND

Many companies rely on software applications to conduct their business. Software applications deal with various aspects of companies' businesses, which can include finances, accounting, product development, human resources, customer service, management, and many other aspects. Software applications typically operate from servers and can be stored in memory. To use software applications, users typically employ various computing devices. Further, software applications involve a plurality of executable processes. Determination and arrangement of a specific order of such processes as they relate to aspects of finances, accounting, product development, human resources, customer service, management, etc. is oftentimes challenging and burdensome on users, leading to inefficient of execution of processes, errors, and other issues.

### SUMMARY

In some implementations, the current subject matter relates to a computer implemented method for defining and implementing various process sequences. The method may include identifying, using at least one processor, one or more first processing parameters for executing a sequence of processes. The sequence of processes may include a plurality of executable computing processes. The first processing parameters may define one or more periods of time associated with executing of the sequence of processes. The method may also include determining at least one subject matter domain parameter associated with the sequence of processes, selecting, based on at least one subject matter domain parameter, one or more executable computing processes in the plurality of executable computing processes for inclusion in the sequence of processes, generating the sequence of processes having the selected executable computing processes arranged for execution using a predetermined execution order, and executing each of the selected executable computing processes in the sequence of processes in accordance with the predetermined execution order.

In some implementations, the current subject matter may include one or more of the following optional features. At least one of the selected executable computing processes may depend on an execution of at least another one of the selected executable computing processes in the sequence of processes. For example, the processes may be related using a parent-child process relationship, e.g., where result and/or completion of execution of one process (e.g., parent) may be required for execution of another process (e.g., child).

In some implementations, at least one of the selected executable computing processes in the sequence of processes may be configured to be repeatedly executed using at least one processor.

In some implementations, one or more periods of time may include a future period of time. Execution of the sequence of processes may include executing at least one of the selected executable computing processes in the sequence of processes to forecast at least one result of execution of the selected executable computing processes at the future period of time.

In some implementations, one or more periods of time may include a past period of time. Execution of the sequence of processes may include executing at least one of the selected executable computing processes in the sequence of processes to update at least one obtained result of execution of the selected executable computing processes at the past period of time.

In some implementations, at least one of the selected executable computing processes in the sequence of processes may include at least one nested executable computing process. These may include sub-processes and/or other dependent processes.

In some implementations, the subject matter domain parameter may include an accounting subject matter domain parameter.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary system for defining and implementing various process sequences, according to some implementations of the current subject matter;

FIG. 2 illustrates an exemplary interface that may be used for defining a particular process sequence for execution, according to some implementations of the current subject matter;

FIG. 3 is a table illustrating exemplary process sequences associated with a particular domain that may have been generated as a result of entering information in the interface shown in FIG. 2, according to some implementations of the current subject matter;

FIG. 4 is a table illustrating exemplary past and future process sequences, according to some implementations of the current subject matter;

FIG. 5 is a diagram illustrating an exemplary system including a data storage application, according to some implementations of the current subject matter;

FIG. 6 is a diagram illustrating details of the system of FIG. 5;

FIG. 7 is an exemplary system, according to some implementations of the current subject matter; and

FIG. 8 is an exemplary method, according to some implementations of the current subject matter.

### DETAILED DESCRIPTION

To address these and potentially other deficiencies of currently available solutions, one or more implementations of the current subject matter relate to methods, systems, articles of manufacture, and the like that may, in some implementations, provide a computing environment for defining and implementing various process sequences, such as for example, accounting process sequences.

In some implementations, the current subject matter may be configured to provide a computing environment that may be used for definition, such as, substantially error-free definition, and implementation of various accounting process sequences. To do so, the current subject matter may be configured generate a list or a chain of processes that may need to be executed using one or more process sequence variants and/or variations. The list of processes may be generated in accordance with various process domains that may be selectable prior to execution of the processes, where the process domains define specific processes and order in which such processes are to be executed. Once the lists of processes have been defined, the current subject matter may be configured to execute each of the processes in the list of processes (where one or more of the same processes may be executed several times) using one or more defined parameters. As a result of execution of the processes, one or more reports may be generated (e.g., accounting reports).

In some implementations, the current subject matter may be configured to propagate one or more process selection parameters of a particular process chain from one or more parent processes (e.g., process that may be executed independently of another process that may depend on results of its execution, i.e., a child process) to one or more child processes. This may ensure that the parameter settings of all triggered reports have the same and correct parameter configuration at runtime.

One or more processes may be configured to trigger one or more child process in a correct sequence order and, most decisively, automatically identify one or more proper process domain that may need to be assigned at each specific step in the sequence. If, for example, a specific step may require a domain (e.g., accounting domain “500”), then the current subject matter system may be configured to automatically identify appropriate parameters, data, etc. that may be needed (e.g., contracts and/or portfolios that may be relevant in an accounting step).

In some exemplary, non-limiting implementations, the current subject matter system may be applicable to one or more accounting processes. Accounting processing may be characterized by specific procedural complexities. For example, it may include approximately 15 to 30 different technical processes. Such technical processes may conduct one or more specific determinations regarding information production, information presentation, etc. Each process may be configurable with approximately 3 to 5 system parameters, e.g., company code, accounting methodologies, contractual source systems, business domains, posting date, etc. The processes may need to be scheduled in a particular order such that dependencies are properly taken into account. This may mean that the single accounting processes may be needed, otherwise, one or more logical dependencies might not be taken into account.

The above situation allows for a high degree of freedom in setting system parameters and/or in defining scheduling sequence(s). The following is an example of quantifying this complexity. Assume that a system may include about 10 to 100 company codes, 2 to 10 accounting methodologies, and a high number of contractual source systems for approximately 5 business domains. Even though there are only 15 to 30 different processes, these may need to be scheduled in a proper order regarding the domains for the same set of company codes and/or accounting methodologies for a particular posting date.

This complexity, due to the high degree of freedom, as mentioned above, may lead to significant problems. One of the most significant ones may include an inappropriate scheduling of processes in one or more domains for the same set of company codes and accounting methodologies for a particular posting date. In such an erroneous process schedule either the domains are processed in the wrong order, and/or even the processes within a specific domain are scheduled in a wrong sequence. This may lead to inconsistencies in the balance sheet and/or profit and loss statement that may be hard to identify and/or resolve.

To resolve the above issues, the current subject matter may be configured to generate one or more well-formed and unchangeable definitions of correct process sequences, and generate and, subsequently execute, coded implementations of these process sequence definitions. Thus, instead of having to schedule 15 to 30 accounting processes separately (as in the example above) with a process specific configuration of system parameters (e.g., company code, accounting methodologies, contractual source systems, domains, posting date, etc.), the current subject matter may be configured to provide a single compact process (e.g., accounting process) to be scheduled. The sequence of processes may be defined using the compact process itself; the system parameters may be automatically propagated from the compact process to each single child processes. The sequence of single child processes may be generated automatically in a correct order, thereby resolving any confusion of system parameters.

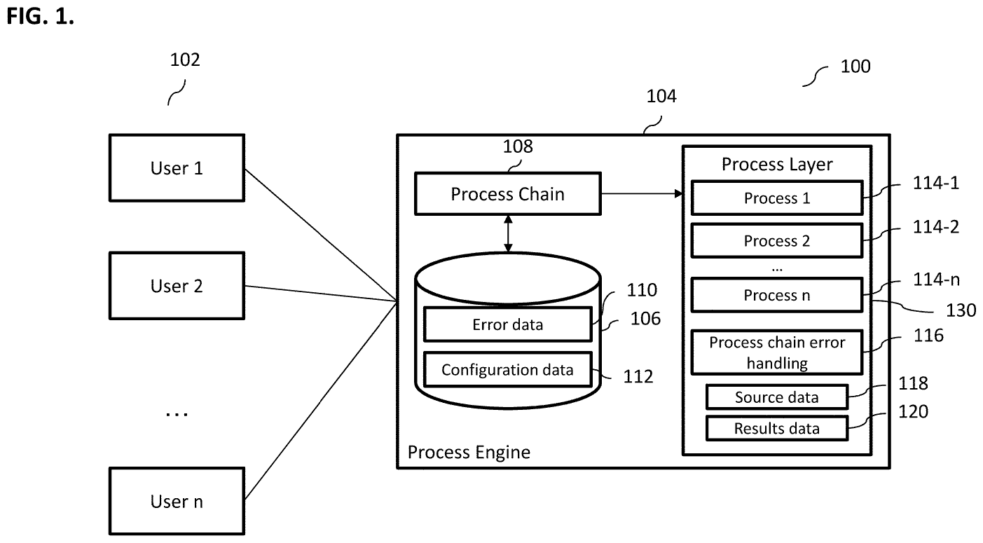

FIG. 1 illustrates an exemplary system 100 for defining and implementing various process sequences, according to some implementations of the current subject matter. The system 100 may be configured to operate in one or more clustered computing environments (e.g., Kubernetes), one or more cloud environments, etc. It may include one or more users, entities, applications, etc. 102 (e.g., user 1, user 2, . . . , user n, etc.), which may include one or more end-users, administrator users, etc. that may be configured to access system 100 using one or more browsers, user interfaces, application interfaces, and/or any other interfaces. It may also include a process engine/system 104. The system 104 may include one or more computing elements (which may, for example, as discussed below, include one or more processors, one or more servers, one or more computing engines, one or more memory and/or storage locations, one or more databases, etc.) such as, one or more databases 106 that may store computing process error data 110 and/or computing configuration data, one or more process chain(s) 108 (e.g., “/BA1/RFC_PROCESS_CHAIN”), and one or more process layers 130. The process layers 130 may be configured to include one or more processes 1, 2, . . . , n 114-1, 114-2, . . . 114-n (hereinafter, “114”), a process chain error handling component 116, a process source data component 118, and a process results data component 120. Various components of the system 100 may be communicatively coupled using various communication protocols, including but not limited to REST protocol, HTTP protocol, OData protocol, SOAP protocol, etc. Moreover, the system 100 may be configured to include one or more application programming interfaces for ensuring connectivity among various elements of the system 100.

The engine 104 may include a processor, a memory, and/or any combination of hardware/software, and may be configured to allow one or more users 102 to communicate with the engine 104, such as, for the purposes of defining, implementing and/or executing one or more processes 114 using one or more parameters. The defined/implemented processes 114 may include one or more or specific software applications, one or more computing processes, one or more computing steps that may be executed by one or more processors, along with any associated data and/or content, and/or any configuration data that may specify one or more functions and/or features of the software application(s), data and/or content. A defined/implemented process 114 in the process chain 108 may include one or more other processes, child processes, and/or sub-processes. In some cases, a particular process 114 may be configured to rely on data, functions and/or features (and/or any combination thereof) of a computing component such that the process is an integration and/or a combination of one or more computing components, processes, etc. A process 114 may use one or more computing components that may refer to a software code that may be configured to perform a particular function, a piece and/or a set of data (e.g., data unique to a particular accounting process and/or data available to a plurality of accounting processes, and/or any other processes) and/or configuration data used to create, modify, etc. one or more software functionalities associated with a particular process 114, child process, sub-process, and/or a portion of a process that may be desired to be executed by one or more users 102 within a particular process domain. A process domain may be referred to as an ordered sequence of computing processes defined in accordance with one or more parameters, where execution of one process may depend on results and/or completion of execution of another process. The system 104 may include one or more artificial intelligence and/or learning capabilities that may rely on and/or use various data, e.g., data related to and/or defining one or more processes 114 based on various existing parameters, historical data associated with definition, implementation and/or execution of other processes.

The elements of the system 100 may be communicatively coupled using one or more communications networks. The communications networks can include at least one of the following: a wired network, a wireless network, a metropolitan area network (“MAN”), a local area network (“LAN”), a wide area network (“WAN”), a virtual local area network (“VLAN”), an internet, an extranet, an intranet, and/or any other type of network and/or any combination thereof.

Moreover, the elements of the system 100 may include any combination of hardware and/or software. In some implementations, the elements may be disposed on one or more computing devices, such as, server(s), database(s), personal computer(s), laptop(s), cellular telephone(s), smartphone(s), tablet computer(s), and/or any other computing devices and/or any combination thereof. In some implementations, the elements may be disposed on a single computing device and/or can be part of a single communications network. Alternatively, the elements may be separately located from one another.

As stated above, the user 102 may be an end user (e.g., a business user), and/or an administrator user. The end user 102 may be configured to use various tools that may be available to the user 102 in defining a particular process 114 and/or requesting execution of particular process(es) and/or process(es) within a particular process domain (e.g., quarterly reports, etc.). The users 102 may be configured to cause (e.g., via one or more user interfaces associated with engine 104) definition, implementation, and/or execution of one or more processes 114.

The process chain component 108 may be configured to define a particular sequence of execution of one or more processes 114. To determine a particular process sequence, the component 108 may access database 106 and obtain appropriate configuration data 112 and/or error handling data 110 that may be used to structure the sequence in a predetermined order. The order may be pre-defined by a particular process domain (e.g., quarterly report in accounting, etc.) and/or defined by the user 102.

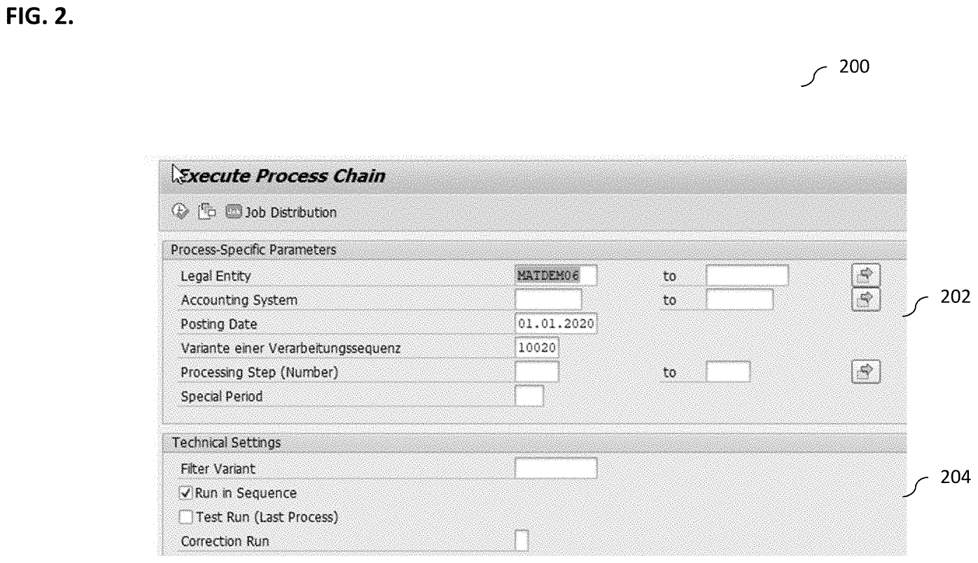

FIG. 2 illustrates an exemplary interface 200 that may be used for defining a particular process sequence for execution, according to some implementations of the current subject matter. As stated above, the defined sequence may include one or more processes, one or more child processes (e.g., processes that require execution of another process(es) and/or depend on results of execution of another process(es)), sub-processes and/or nested processes, and/or any other processes. The interface 200 may be a user interface and/or any other type of interface. The interface 200 may include one or more portions 202, 204 that may be used to define a specific process chain for execution.

For example, portion 202 may be configured to define one or more process-specific parameters. As shown in FIG. 2, such parameters may include, but are not limited to, a “legal entity”, an “accounting system”, a “posting date”, a “variant”, a “processing step”, a “special period” and/or any other parameters. The legal entity parameter may correspond to a company code. The accounting system parameter may, for instance, identify a particular the accounting methodology. The posting date parameter may correspond to a date for which the various determinations, calculations, analysis, etc. are being performed. The processing variant parameter can identify a variant of the processing sequence, e.g., it may be specific for a particular logical point in time and/or may be associated with a particular selection and/or order of processes. The processing step (number) parameter can be used to select a specific process from within a particular process sequence. These parameters may be predetermined by the system 100, defined by one or more users 102, automatically defined (e.g., based on a specific subject matter for which execution of processes is requested), and/or determined in any other way. The parameters may be used to generate one or more sequences of processes for execution. The parameters may further be used to exclude one or more processes from being included in the generated sequences of processes. Each parameter may be associated with one or more ranges. For example, “posting date” parameter is the specific processing (business) date, which may be past and/or even a future date. Parameter ranges may allow for executing corrections for previously executed processes (and thus, updating their results). Alternatively, or in addition to, parameter ranges may be set for the purposes of executing forecasting processes to determine how processes may be executed in the future and/or what results may be obtained.

Moreover, portion 204 of the interface 200 shown in FIG. 2 may be used to apply one or more technical settings to the generated sequence of processes. Such settings may indicate that the processes included in the sequence of processes may need to be executed in a particular order, may need to be re-executed to correct various errors (e.g., “correction run”), and/or may need to be test-executed. The filter variant parameter in the technical settings portion 204 can correspond to a setting for protocols and/or logs. The special period parameter can define one or more additional accounting periods (e.g., on a last day of a fiscal year). The run-in-sequence parameter indicates that the process execution may use parallel processing for a particular process within a processing sequence, and/or the execution may be triggered sequentially. The test run (e.g., last process only) parameter may be defined for a particular processing sequence the last process may be triggered in a test mode, which may mean that it does not store results in the database but may show the results in a list display. The correction run parameter may correspond to the process chain report that may process all data and/or only that data that was erroneous in a previous execution. As can be understood, any other technical settings may be applied.

In some implementations, one or more domains (e.g., a subject matter domain) or source system categories may be defined and/or assigned (e.g., from a plurality of existing domains) to each process in the process sequence. An assigned domain may be configured to categorize a particular source system. A source system may be a property of a particular content-related system (e.g., a contract, a portfolio, a ledger, etc.). The content-related system may correspond to an entity on which a particular processing (e.g., accounting processing) may be performed.

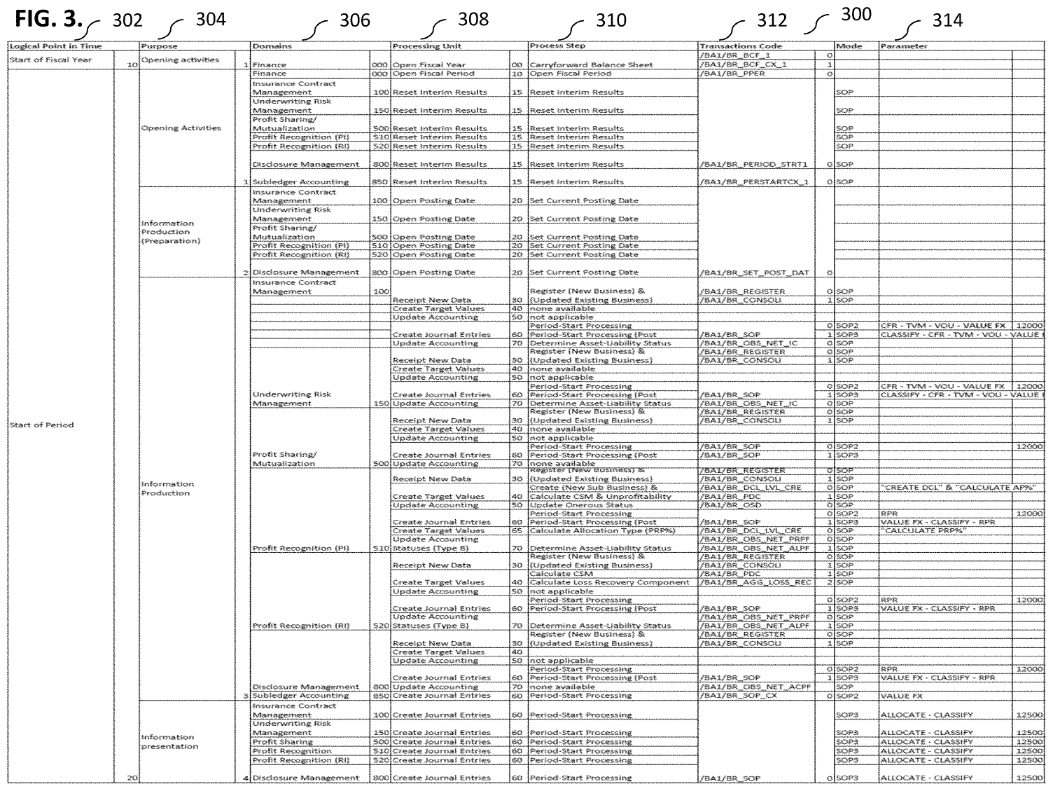

FIG. 3 is a table 300 illustrating exemplary process sequences associated with a particular domain that may have been generated as a result of entering information in the interface 200 shown in FIG. 2, according to some implementations of the current subject matter. As can be understood, the table 300 may include a plurality of such process sequences. Table 300 is illustrated in connection with accounting processes. However, as can be understood, such process sequence definitions may be generated in connection with any desired processes.

Each process sequence may be defined using one or more process parameters 302-314 and/or others. The process parameters may be configured to identify one or more processes and/or grouping of processes that may need to be executed. The process parameters may include one or more logical points in time 302 (e.g., “start of fiscal year”, “start of period”, etc.), each of which may be executed in a particular order, e.g., as indicated by numbers “10”, “20” shown next to each point in time 302.

Within in each point in time process parameter 302, a purpose process parameter 304 may be defined. For example, the “start of fiscal year” parameter 302 may include “opening activities”. The start of period” parameter 302 may include several purpose parameters 304. For example, these may include “opening activities”, “information production (preparation)”, “information production”, and “information presentation” parameters 304. An order of execution of each of these may be defined, as indicated by the corresponding columns, e.g., “1”, “2”, “3”, “4”.

Within each purpose processing parameter 304, a “domain” processing parameter 306 may be defined. For example, parameters 306 may include “finance”, “insurance contract management”, “underwriting risk management” and others. Each domain parameter 306 may include one or more parameters corresponding to one or more processes and/or groups of processes that may be executed within that domain, which is in turn, defined within a particular purpose parameter 304, and limited by a particular logical point in time parameter 302. Each domain parameter 306 can also be associated with a particular identifier, e.g., “000”, “100”, “500”, etc.

Once the domain parameter 306 has been defined, one or more processing units 308 can be identified for execution of the processes associated therewith. For example, in the accounting processes, the processing units 308 can include “open fiscal year”, “open fiscal period”, “reset interim results”, etc. Each processing unit parameter 308 may also be associated with a particular process step parameter 310, such as, for example, “reset interim results”, “set current posting date”, etc.

Further, each process step parameter 310 may also be associated with a “transaction code” 312. For example, the process step parameter “reset interim results” may be associated with transaction code “/BA1/BR_PERIOD_STRT1”. As shown in FIG. 3, one transaction code 312 may be associated with multiple domains and may correspond to associated process units/steps 308, 310. For example, a single transaction code “/BA1/BR_PERIOD_STRT1” 312 may be associated with multiple domains 306 (e.g., “finance”, “insurance contract management”, “underwriting risk management”, etc.) in the “opening activities” parameter 304 for the “start of period” parameter 302. Each transaction code 312 can be associated with one or more “mode” and/or other “parameters” 314 that may further define which processes may need to be executed.

Once the processes have been identified using parameters 302-314, the engine 104 may be configured to access one or more processing components that may be associated with one or more of the identified processes. The components may be configured to execute the identified processes and generate results.

In some implementations, execution of one or more processes that have been identified by the above parameters may depend on execution of one or more other processes and/or results of such processes. This means that the plurality of processes that have been identified (e.g., as shown in FIG. 3) may be configured to be executed in a particular sequence. The sequence may be defined in accordance with one or more parameters 302-314.

In some exemplary implementations, the processes sequence may be defined to execute processes that may have been previously executed (e.g., in the past point in time). Execution of such sequence may be performed, for instance, to correct one or more results of previous executions of processes. Alternatively, or in addition to, the processes sequence may be defined to execute processes that have yet to be executed (e.g., in the future point in time). Execution of such sequence may be performed, for instance, to forecast and/or predict one or more results of future executions of processes.

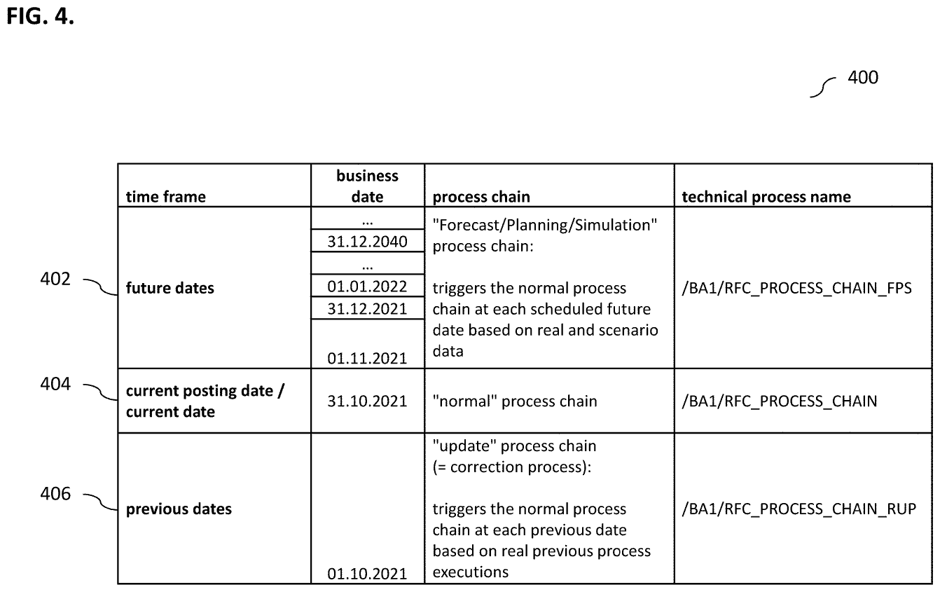

FIG. 4 is a table 400 illustrating exemplary past and future process sequences, according to some implementations of the current subject matter. As shown in FIG. 4, a future process sequence 402 may define future posting date, e.g., “31.12.2040” in relation to the current posting date 404, e.g., “31.10.2021” and defined by process name “/BA1/RFC_PROCESS_CHAIN”. The future process sequence 402 may define a “Forecast/Planning/Simulation” process sequence/chain that may be configured to trigger a normal process sequence/chain at each scheduled future date based on real data and/or various scenarios data, and may be identified by a process name “/BA1/RFC_PROCESS_CHAIN_FPS”.

Similarly, a past process sequence 406 may define a past or previous posting date, e.g., “01.10.2021” in relation to the current posting date 404, e.g., “31.10.2021”. The past process sequence 406 may define an “update” process sequence/chain (e.g., a correction process) that may be configured to trigger a normal process sequence/chain at each previous date based on real previous process executions, and may be identified by a process name “/BA1/RFC_PROCESS_CHAIN_RUP”.

In some implementations, the current subject matter may be implemented in various in-memory database systems, such as a High Performance Analytic Appliance (“HANA”) system as developed by SAP SE, Walldorf, Germany. Various systems, such as, enterprise resource planning (“ERP”) system, supply chain management system (“SCM”) system, supplier relationship management (“SRM”) system, customer relationship management (“CRM”) system, and/or others, may interact with the in-memory system for the purposes of accessing data, for example. Other systems and/or combinations of systems may be used for implementations of the current subject matter. The following is a discussion of an exemplary in-memory system.

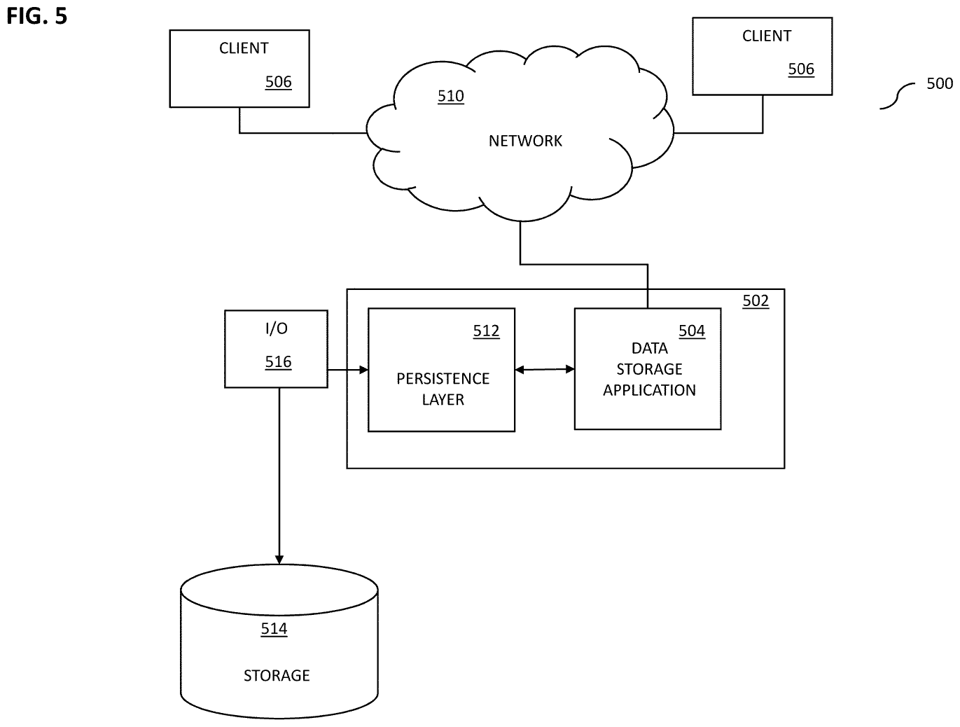

FIG. 5 illustrates an exemplary system 500 in which a computing system 502, which may include one or more programmable processors that may be collocated, linked over one or more networks, etc., executes one or more modules, software components, or the like of a data storage application 504, according to some implementations of the current subject matter. The data storage application 504 may include one or more of a database, an enterprise resource program, a distributed storage system (e.g. NetApp Filer available from NetApp of Sunnyvale, Calif.), or the like.

The one or more modules, software components, or the like may be accessible to local users of the computing system 502 as well as to remote users accessing the computing system 502 from one or more client machines 506 over a network connection 510. One or more user interface screens produced by the one or more first modules may be displayed to a user, either via a local display or via a display associated with one of the client machines 506. Data units of the data storage application 504 may be transiently stored in a persistence layer 512 (e.g., a page buffer or other type of temporary persistency layer), which may write the data, in the form of storage pages, to one or more storages 514, for example via an input/output component 516. The one or more storages 514 may include one or more physical storage media or devices (e.g. hard disk drives, persistent flash memory, random access memory, optical media, magnetic media, and the like) configured for writing data for longer term storage. It should be noted that the storage 514 and the input/output component 516 may be included in the computing system 502 despite their being shown as external to the computing system 502 in FIG. 5.

Data retained at the longer term storage 514 may be organized in pages, each of which has allocated to it a defined amount of storage space. In some implementations, the amount of storage space allocated to each page may be constant and fixed. However, other implementations in which the amount of storage space allocated to each page may vary are also within the scope of the current subject matter.

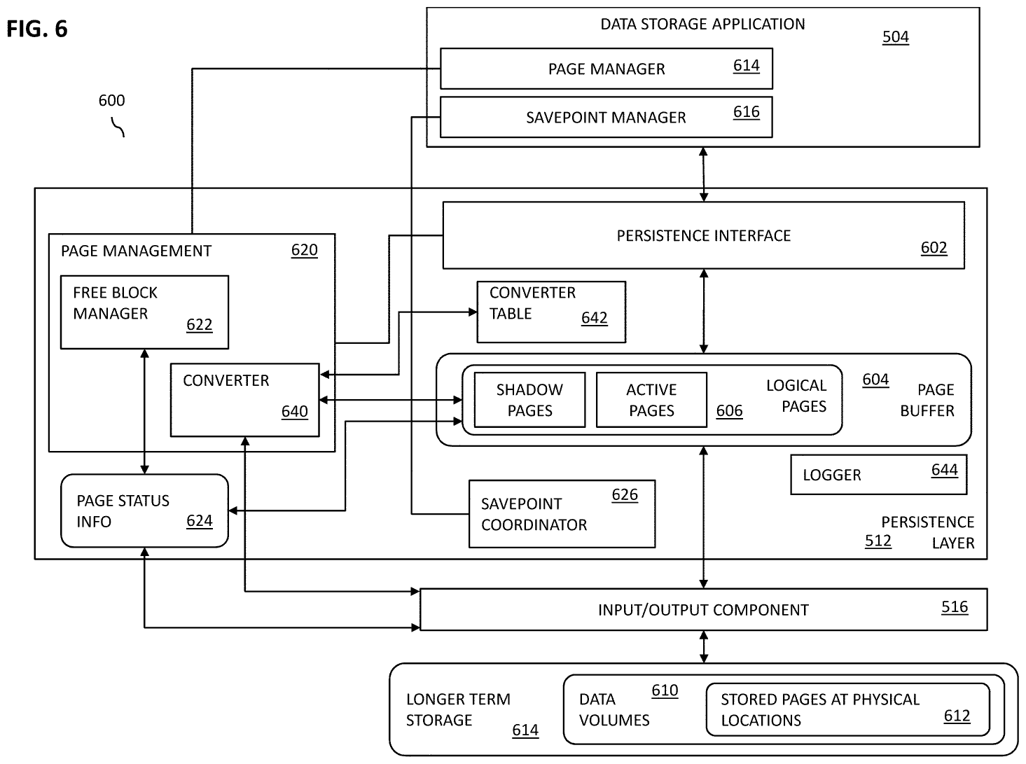

FIG. 6 illustrates exemplary software architecture 600, according to some implementations of the current subject matter. A data storage application 504, which may be implemented in one or more of hardware and software, may include one or more of a database application, a network-attached storage system, or the like. According to at least some implementations of the current subject matter, such a data storage application 504 may include or otherwise interface with a persistence layer 512 or other type of memory buffer, for example via a persistence interface 602. A page buffer 604 within the persistence layer 512 may store one or more logical pages 606, and optionally may include shadow pages, active pages, and the like. The logical pages 606 retained in the persistence layer 512 may be written to a storage (e.g. a longer term storage, etc.) 514 via an input/output component 516, which may be a software module, a sub-system implemented in one or more of software and hardware, or the like. The storage 514 may include one or more data volumes 610 where stored pages 612 are allocated at physical memory blocks.

In some implementations, the data storage application 504 may include or be otherwise in communication with a page manager 614 and/or a savepoint manager 616. The page manager 614 may communicate with a page management module 620 at the persistence layer 512 that may include a free block manager 622 that monitors page status information 624, for example the status of physical pages within the storage 514 and logical pages in the persistence layer 512 (and optionally in the page buffer 604). The savepoint manager 616 may communicate with a savepoint coordinator 626 at the persistence layer 512 to handle savepoints, which are used to create a consistent persistent state of the database for restart after a possible crash.

In some implementations of a data storage application 504, the page management module of the persistence layer 512 may implement a shadow paging. The free block manager 622 within the page management module 620 may maintain the status of physical pages. The page buffer 604 may include a fixed page status buffer that operates as discussed herein. A converter component 640, which may be part of or in communication with the page management module 620, may be responsible for mapping between logical and physical pages written to the storage 514. The converter 640 may maintain the current mapping of logical pages to the corresponding physical pages in a converter table 642. The converter 640 may maintain a current mapping of logical pages 606 to the corresponding physical pages in one or more converter tables 642. When a logical page 606 is read from storage 514, the storage page to be loaded may be looked up from the one or more converter tables 642 using the converter 640. When a logical page is written to storage 514 the first time after a savepoint, a new free physical page is assigned to the logical page. The free block manager 622 marks the new physical page as “used” and the new mapping is stored in the one or more converter tables 642.

The persistence layer 512 may ensure that changes made in the data storage application 504 are durable and that the data storage application 504 may be restored to a most recent committed state after a restart. Writing data to the storage 514 need not be synchronized with the end of the writing transaction. As such, uncommitted changes may be written to disk and committed changes may not yet be written to disk when a writing transaction is finished. After a system crash, changes made by transactions that were not finished may be rolled back. Changes occurring by already committed transactions should not be lost in this process. A logger component 644 may also be included to store the changes made to the data of the data storage application in a linear log. The logger component 644 may be used during recovery to replay operations since a last savepoint to ensure that all operations are applied to the data and that transactions with a logged “commit” record are committed before rolling back still-open transactions at the end of a recovery process.

With some data storage applications, writing data to a disk is not necessarily synchronized with the end of the writing transaction. Situations may occur in which uncommitted changes are written to disk and while, at the same time, committed changes are not yet written to disk when the writing transaction is finished. After a system crash, changes made by transactions that were not finished must be rolled back and changes by committed transaction must not be lost.

To ensure that committed changes are not lost, redo log information may be written by the logger component 644 whenever a change is made. This information may be written to disk at latest when the transaction ends. The log entries may be persisted in separate log volumes while normal data is written to data volumes. With a redo log, committed changes may be restored even if the corresponding data pages were not written to disk. For undoing uncommitted changes, the persistence layer 512 may use a combination of undo log entries (from one or more logs) and shadow paging.

The persistence interface 602 may handle read and write requests of stores (e.g., in-memory stores, etc.). The persistence interface 602 may also provide write methods for writing data both with logging and without logging. If the logged write operations are used, the persistence interface 602 invokes the logger 644. In addition, the logger 644 provides an interface that allows stores (e.g., in-memory stores, etc.) to directly add log entries into a log queue. The logger interface also provides methods to request that log entries in the in-memory log queue are flushed to disk.

Log entries contain a log sequence number, the type of the log entry and the identifier of the transaction. Depending on the operation type additional information is logged by the logger 644. For an entry of type “update”, for example, this would be the identification of the affected record and the after image of the modified data.

When the data application 504 is restarted, the log entries need to be processed. To speed up this process the redo log is not always processed from the beginning. Instead, as stated above, savepoints may be periodically performed that write all changes to disk that were made (e.g., in memory, etc.) since the last savepoint. When starting up the system, only the logs created after the last savepoint need to be processed. After the next backup operation the old log entries before the savepoint position may be removed.

When the logger 644 is invoked for writing log entries, it does not immediately write to disk. Instead it may put the log entries into a log queue in memory. The entries in the log queue may be written to disk at the latest when the corresponding transaction is finished (committed or aborted). To guarantee that the committed changes are not lost, the commit operation is not successfully finished before the corresponding log entries are flushed to disk. Writing log queue entries to disk may also be triggered by other events, for example when log queue pages are full or when a savepoint is performed.

With the current subject matter, the logger 644 may write a database log (or simply referred to herein as a “log”) sequentially into a memory buffer in natural order (e.g., sequential order, etc.). If several physical hard disks/storage devices are used to store log data, several log partitions may be defined. Thereafter, the logger 644 (which as stated above acts to generate and organize log data) may load-balance writing to log buffers over all available log partitions. In some cases, the load-balancing is according to a round-robin distributions scheme in which various writing operations are directed to log buffers in a sequential and continuous manner. With this arrangement, log buffers written to a single log segment of a particular partition of a multi-partition log are not consecutive. However, the log buffers may be reordered from log segments of all partitions during recovery to the proper order.

As stated above, the data storage application 504 may use shadow paging so that the savepoint manager 616 may write a transactionally-consistent savepoint. With such an arrangement, a data backup comprises a copy of all data pages contained in a particular savepoint, which was done as the first step of the data backup process. The current subject matter may be also applied to other types of data page storage.

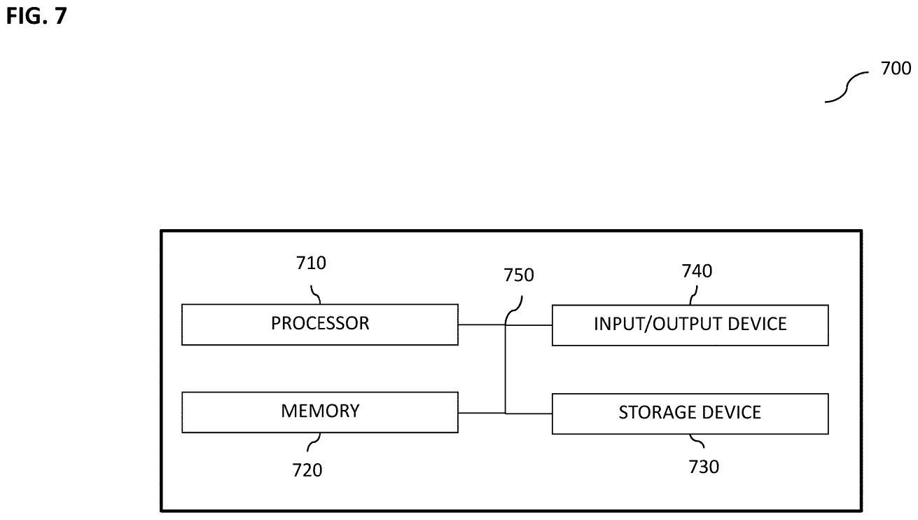

In some implementations, the current subject matter may be configured to be implemented in a system 700, as shown in FIG. 7. The system 700 may include a processor 710, a memory 720, a storage device 730, and an input/output device 740. Each of the components 710, 720, 730 and 740 may be interconnected using a system bus 750. The processor 710 may be configured to process instructions for execution within the system 700. In some implementations, the processor 710 may be a single-threaded processor. In alternate implementations, the processor 710 may be a multi-threaded processor. The processor 710 may be further configured to process instructions stored in the memory 720 or on the storage device 730, including receiving or sending information through the input/output device 740. The memory 720 may store information within the system 700. In some implementations, the memory 720 may be a computer-readable medium. In alternate implementations, the memory 720 may be a volatile memory unit. In yet some implementations, the memory 720 may be a non-volatile memory unit. The storage device 730 may be capable of providing mass storage for the system 700. In some implementations, the storage device 730 may be a computer-readable medium. In alternate implementations, the storage device 730 may be a floppy disk device, a hard disk device, an optical disk device, a tape device, non-volatile solid state memory, or any other type of storage device. The input/output device 740 may be configured to provide input/output operations for the system 700. In some implementations, the input/output device 740 may include a keyboard and/or pointing device. In alternate implementations, the input/output device 740 may include a display unit for displaying graphical user interfaces.

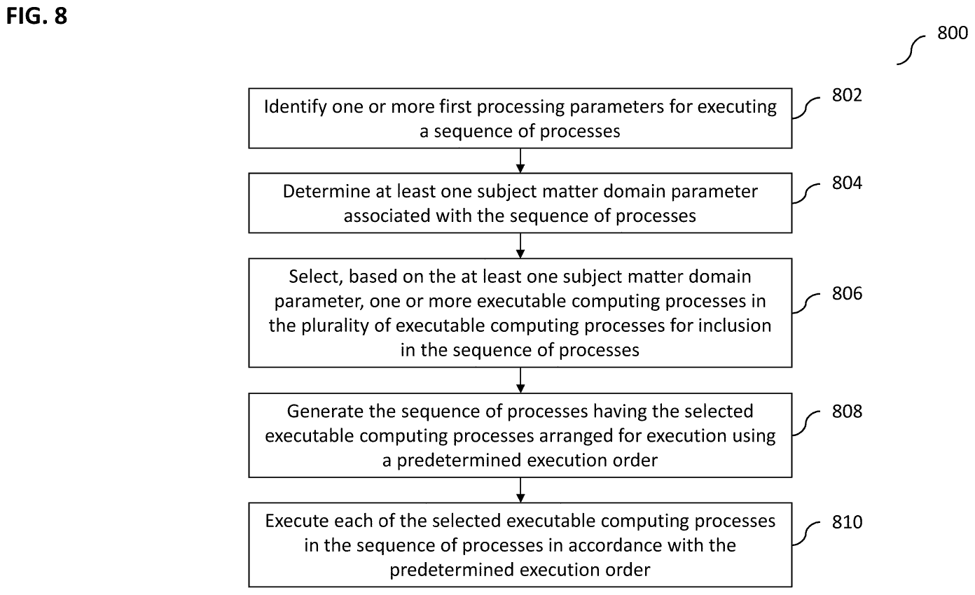

FIG. 8 illustrates an exemplary method 800 for defining and implementing various process sequences, according to some implementations of the current subject matter. The method 800 may be performed by the system shown in FIG. 1 and in particular the engine 104, including its process chain component 108 and/or process layer 130.

At 802, at least one processor (e.g., engine 104 shown in FIG. 1) may identify one or more first processing parameters (e.g., “logical point in time” parameters 302 shown in FIG. 3) for executing a sequence of processes. The sequence of processes may include a plurality of executable computing processes. As stated above, the first processing parameter(s) may define one or more periods of time associated with executing of the sequence of processes.

At 804, the engine 104 may determine at least one subject matter domain parameter associated with the sequence of processes. For example, these parameters may include domain parameter 306, as shown in FIG. 3, and may include “finance”, “insurance contract management”, etc.

At 806, the engine 104 may select based on the subject matter domain parameter 306, one or more executable computing processes (e.g., processes 310 identified by transaction codes 312 shown in FIG. 3) in the plurality of executable computing processes for inclusion in the sequence of processes.

At 808, the engine 104 may generate the sequence of processes having the selected executable computing processes arranged for execution using a predetermined execution order. FIG. 3 illustrates an exemplary order of execution of various processes as defined by specific parameters 302-314.

At 810, the engine 104 may execute each of the selected executable computing processes in the sequence of processes in accordance with the predetermined execution order.

In some implementations, the current subject matter may include one or more of the following optional features. At least one of the selected executable computing processes may depend on an execution of at least another one of the selected executable computing processes in the sequence of processes. For example, the processes may be related using a parent-child process relationship, e.g., where result and/or completion of execution of one process (e.g., parent) may be required for execution of another process (e.g., child).

In some implementations, at least one of the selected executable computing processes in the sequence of processes may be configured to be repeatedly executed using the at least one processor. For example, one or more processes identified by transaction code 312 may be repeatedly executed for a particular process step 310, as shown in FIG. 3.

In some implementations, one or more periods of time may include a future period of time (e.g., as shown in FIG. 4). Execution of the sequence of processes may include executing at least one of the selected executable computing processes in the sequence of processes to forecast at least one result of execution of the selected executable computing processes at the future period of time.

In some implementations, one or more periods of time may include a past period of time (e.g., as is also shown in FIG. 4). Execution of the sequence of processes may include executing at least one of the selected executable computing processes in the sequence of processes to update at least one obtained result of execution of the selected executable computing processes at the past period of time.

In some implementations, at least one of the selected executable computing processes in the sequence of processes may include at least one nested executable computing process. These may include sub-processes and/or other dependent processes.

In some implementations, the subject matter domain parameter may include an accounting subject matter domain parameter. This is shown by parameter domain 306, as shown in FIG. 3, for example.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality.

The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
identifying, using at least one processor, one or more first processing parameters for executing a sequence of processes, the sequence of processes including a plurality of executable computing processes, the one or more first processing parameters defining one or more periods of time associated with executing the sequence of processes;
determining, using the at least one processor, at least one subject matter domain parameter associated with the sequence of processes;
selecting, using the at least one processor, based on the at least one subject matter domain parameter, one or more executable computing processes in the plurality of executable computing processes for inclusion in the sequence of processes;
generating, using the at least one processor, the sequence of processes having the selected one or more executable computing processes arranged for execution using a predetermined execution order; and
executing, using the at least one processor, each of the selected executable computing processes in the sequence of processes in accordance with the predetermined execution order.

2. The method according to claim 1, wherein at least one of the selected executable computing processes depends on an execution of at least another one of the selected executable computing processes in the sequence of processes.

3. The method according to claim 1, wherein at least one of the selected executable computing processes in the sequence of processes is configured to be repeatedly executed using the at least one processor.

4. The method according to claim 1, wherein the one or more periods of time includes a future period of time;
wherein the executing includes executing, using the at least one processor, at least one of the selected executable computing processes in the sequence of processes to forecast at least one result of execution of the at least one of the selected executable computing processes at the future period of time.

5. The method according to claim 1, wherein the one or more periods of time includes a past period of time;
wherein the executing includes executing, using the at least one processor, at least one of the selected executable computing processes in the sequence of processes to update at least one obtained result of execution of the at least one of the selected executable computing processes at the past period of time.

6. The method according to claim 1, wherein at least one of the selected executable computing processes in the sequence of processes includes at least one nested executable computing process.

7. The method according to claim 1, wherein the at least one subject matter domain parameter includes an accounting subject matter domain parameter.

8. A system comprising:
at least one programmable processor; and
a non-transitory machine-readable medium storing instructions that, when executed by the at least one programmable processor, cause the at least one programmable processor to perform operations comprising:
identifying, using at least one processor, one or more first processing parameters for executing a sequence of processes, the sequence of processes including a plurality of executable computing processes, the one or more first processing parameters defining one or more periods of time associated with executing the sequence of processes;
determining, using the at least one processor, at least one subject matter domain parameter associated with the sequence of processes;
selecting, using the at least one processor, based on the at least one subject matter domain parameter, one or more executable computing processes in the plurality of executable computing processes for inclusion in the sequence of processes;
generating, using the at least one processor, the sequence of processes having the selected one or more executable computing processes arranged for execution using a predetermined execution order; and
executing, using the at least one processor, each of the selected executable computing processes in the sequence of processes in accordance with the predetermined execution order.

9. The system according to claim 8, wherein at least one of the selected executable computing processes depends on an execution of at least another one of the selected executable computing processes in the sequence of processes.

10. The system according to claim 8, wherein at least one of the selected executable computing processes in the sequence of processes is configured to be repeatedly executed using the at least one processor.

11. The system according to claim 8, wherein the one or more periods of time includes a future period of time;
wherein the executing includes executing, using the at least one processor, at least one of the selected executable computing processes in the sequence of processes to forecast at least one result of execution of the at least one of the selected executable computing processes at the future period of time.

12. The system according to claim 8, wherein the one or more periods of time includes a past period of time;
wherein the executing includes executing, using the at least one processor, at least one of the selected executable computing processes in the sequence of processes to update at least one obtained result of execution of the at least one of the selected executable computing processes at the past period of time.

13. The system according to claim 8, wherein at least one of the selected executable computing processes in the sequence of processes includes at least one nested executable computing process.

14. The system according to claim 8, wherein the at least one subject matter domain parameter includes an accounting subject matter domain parameter.

15. A computer program product comprising a non-transitory machine-readable medium storing instructions that, when executed by at least one programmable processor, cause the at least one programmable processor to perform operations comprising:
identifying, using at least one processor, one or more first processing parameters for executing a sequence of processes, the sequence of processes including a plurality of executable computing processes, the one or more first processing parameters defining one or more periods of time associated with executing the sequence of processes;
determining, using the at least one processor, at least one subject matter domain parameter associated with the sequence of processes;
selecting, using the at least one processor, based on the at least one subject matter domain parameter, one or more executable computing processes in the plurality of executable computing processes for inclusion in the sequence of processes;
generating, using the at least one processor, the sequence of processes having the selected one or more executable computing processes arranged for execution using a predetermined execution order; and
executing, using the at least one processor, each of the selected executable computing processes in the sequence of processes in accordance with the predetermined execution order.

16. The computer program product according to claim 15, wherein at least one of the selected executable computing processes depends on an execution of at least another one of the selected executable computing processes in the sequence of processes.

17. The computer program product according to claim 15, wherein at least one of the selected executable computing processes in the sequence of processes is configured to be repeatedly executed using the at least one processor.

18. The computer program product according to claim 15, wherein the one or more periods of time includes a future period of time;
wherein the executing includes executing, using the at least one processor, at least one of the selected executable computing processes in the sequence of processes to forecast at least one result of execution of the at least one of the selected executable computing processes at the future period of time.

19. The computer program product according to claim 15, wherein the one or more periods of time includes a past period of time;
wherein the executing includes executing, using the at least one processor, at least one of the selected executable computing processes in the sequence of processes to update at least one obtained result of execution of the at least one of the selected executable computing processes at the past period of time.

20. The computer program product according to claim 15, wherein at least one of the selected executable computing processes in the sequence of processes includes at least one nested executable computing process;
wherein the at least one subject matter domain parameter includes an accounting subject matter domain parameter.
